(19) United States
(12) Patent Application Publication
(10) Pub. No.: US 2011/0318513 A1
(43) Pub. Date: Dec. 29, 2011

(54) METHOD FOR MAKING A FORM PARTY BY 3D WEAVING, AND RESULTING FORM PART

(75) Inventors: David Marsal, Nogent Sur Marne (FR); Xavier Millier, Saint Mery (FR)

(73) Assignee: SNECMA, Paris (FR)

(21) Appl. No.: 13/141,852

(22) PCT Filed: Dec. 22, 2009
(86) PCT No.: PCT/FR2009/052654

§ 371 Date: Sep. 12, 2011

(30) Foreign Application Priority Data
Dec. 23, 2008 (FR) 0858996

(51) Int. Cl. B32B 1/08; B29C 70/40

(52) U.S. Cl. 428/35.7; 156/148

(57) ABSTRACT

A hollow part is obtained by 3D weaving and by impregnation. A preform is made by three-dimensional weaving and by ensuring partial non-interlinking during the weaving, thereby subsequently making it possible to define a cavity within the woven mass, and then to stabilize a shape of the preform during an impregnation stage.

The invention relates to a method of fabricating a hollow part by three-dimensional weaving (known as 3D weaving) of weft yarns and warp yarns that are very strong, e.g. made of carbon fiber, in order to obtain a preform that is subsequently impregnated with a thermosetting resin. More particularly, the invention relates to an improvement that enables cavities to be created in said hollow part.

In order to fabricate hollow parts of considerable mechanical strength, in particular against impact, it is known to use carbon fibers coated in a thermosetting resin.

For example, it is possible to form any part by cutting pre-impregnated woven sheets of carbon fiber yarns, by stacking them to obtain a blank for the desired part, and by bonding them together hot and under pressure.

Such a laminated structure is not optimal, particularly in terms of withstanding impacts, since impacts might give rise to delamination.

Document EP 1 777 063 describes a more effective method for fabricating a hollow part, specifically a turbomachine blade, by 3D weaving of weft yarns and warp yarns. That method makes it possible to obtain parts of exceptional strength, and in particular presenting very good impact resistance, without any risk of delamination.

The invention seeks to provide an improvement to that type of method for fabricating an arbitrary hollow part whenever there is a need to reduce weight and/or to provide a passage.

More precisely, the invention thus provides a method of fabricating a hollow part, the method consisting in making a preform by 3D weaving, by weaving weft yarns through a bundle of warp yarns arranged in a plurality of layers, and by impregnating said preform with a settable resin, the method being characterized in that, during the weaving, it consists in ensuring partial non-interlinking between two sheets of warp yarns and in expanding said preform by creating a cavity of desired shape therein by means of said non-interlinking, and then impregnating said preform as shaped in this way with said resin.

Non-interlinking is a particular feature of weaving that consists in ensuring that no weft yarns pass through a certain plane in the bundle of warp yarns (and more exactly a portion of said plane).

For example, non-interlinking that is advantageous in the context of the invention is obtained by ensuring that at least from a certain stage of weaving, each weft yarn is woven normally in the sides of the preform that is being formed but without ever passing through a central plane zone that is defined between two layers of warp yarns.

If this method of 3D weaving with non-interlinking is continued to the end of the woven preform, then a kind of pouch is obtained that is open or accessible, i.e. that presents the possibility of being expanded while the part is being shaped and during impregnation, in order to obtain the desired cavity.

If the purpose is to reduce the weight of the hollow part, it is possible to insert a solid material into the pouch that presents a density that is less than that of the yarns, for example an expanded material of the foam type. Such a block of low density material has the shape and the dimensions of the desired cavity. Thereafter, final shaping and impregnation of the preform are continued.

On the contrary, if the purpose is to create a utility passage, to obtain a tubular structure, etc., then the operation consisting in creating said cavity is performed by inserting an inflatable member into the preform at the location of said non-interlinking and in filling said inflatable member with a fluid so as to give it the shape and the dimensions of the desired cavity. After impregnation, the fluid and possibly also the inflatable member is/are extracted from the cavity created in this way.

The invention also provides any hollow part obtained by 3D weaving of a preform and by impregnating said preform by means of a settable resin, the part being characterized in that it includes a cavity defined by expanding said preform, as made possible by non-interlinking during the 3D weaving.

As examples, the hollow part may constitute a rudder or a centerboard for a boat.

The invention can be better understood and other advantages thereof appear more clearly in the light of the following description of a method of fabricating a hollow part in accordance with the principle of the invention, described solely by way of examples and with reference to the accompanying drawings, in which:

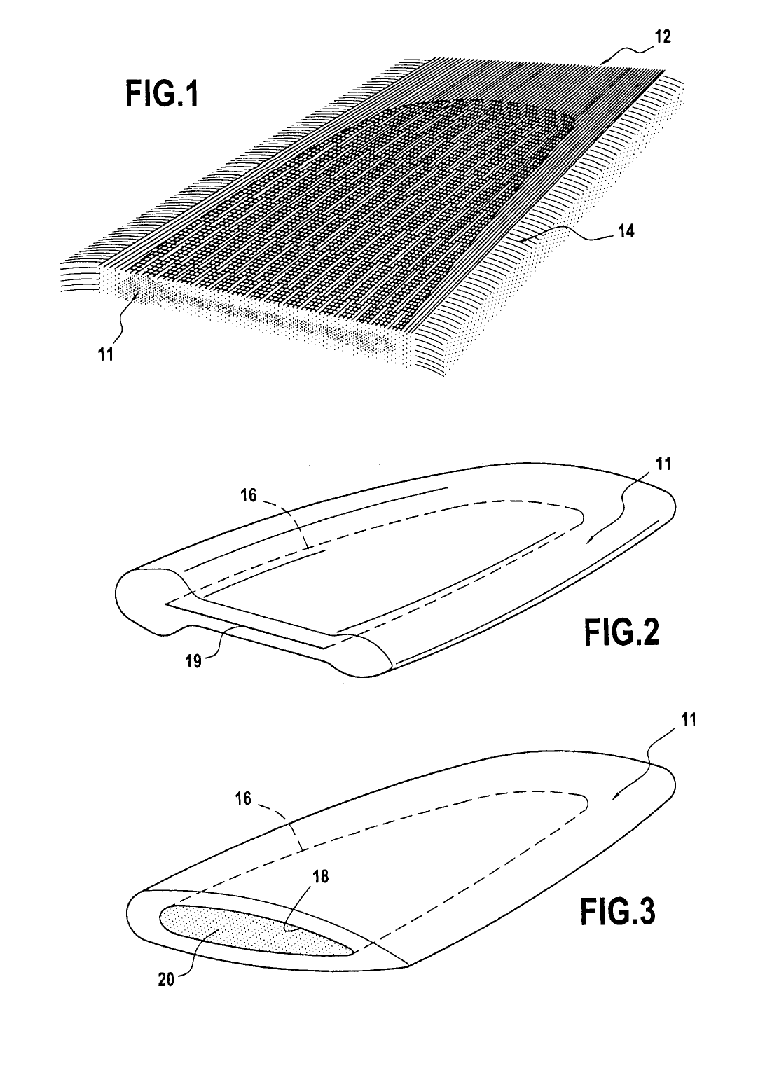

FIG. 1 is a diagrammatic view showing 3D weaving of a preform in order to fabricate a hollow part such as a rudder or a centerboard of a boat;

FIG. 2 is a diagram of the woven preform;

FIG. 3 is a diagram of the preform after it has been shaped by developing a cavity filled with a rigid material of lower density;

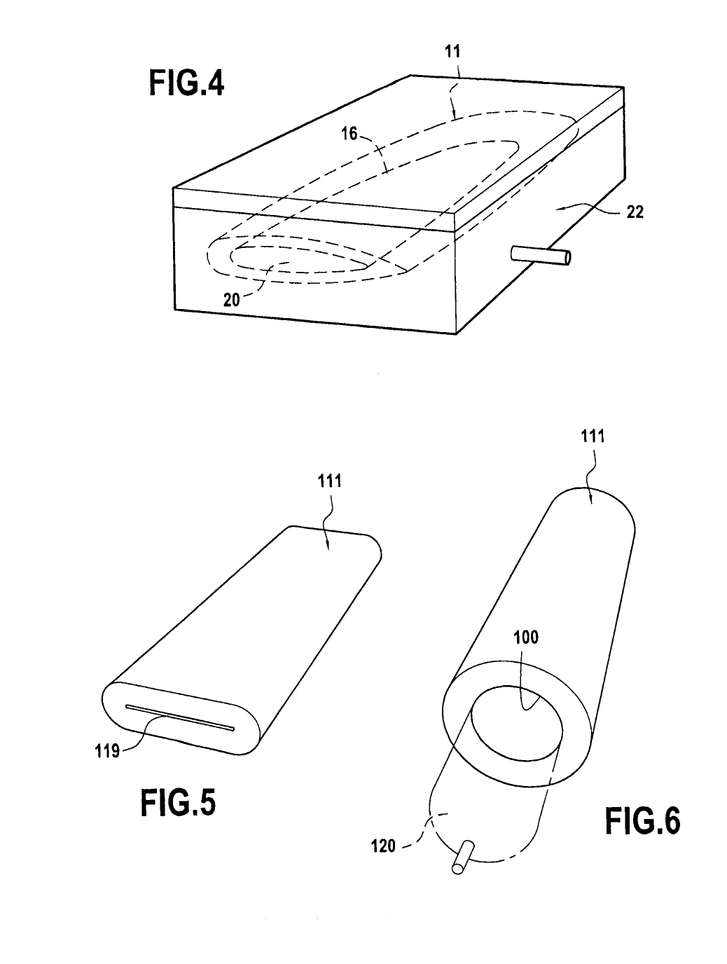

FIG. 4 is a diagram showing impregnation of the preform;

FIG. 5 is a variant of FIG. 2 showing diagrammatically another woven preform; and

FIG. 6 is a diagram showing the shaping of the FIG. 5 preform.

FIG. 1 shows the weaving of a preform 11 that is to be transformed into a rudder for a boat. A Jacquard type loom is used on which a bundle 12 of warp yarns or strands have been placed, being made up of some number of layers each having several hundreds of yarns. The mechanism is such that it is possible to act on each of these yarns transversely to the sheets of warp yarns, as shown, for the purpose of inserting weft yarns 14. As weaving of the preform advances, with the thickness and the width thereof varying, a certain number of warp yarns are not woven, thereby making it possible to define the outline and the continuously variable desired thickness of said preform. At the end of weaving, the warp yarns and the weft yarns are cut at the boundaries of the woven mass in order to extract the preform 11. This is shown in FIG. 2, as it appears at the end of 3D weaving and before any shaping.

According to an important characteristic, the weaving is accompanied by partial non-interlinking 19 between two sheets of warp yarns and within a plane zone defined by the outline 16 in FIG. 2.

As mentioned above, this non-interlinking is a feature of weaving that has the consequence of creating a pouch 18, here a pouch that is open at one end of the woven mass, which pouch is suitable for being expanded during a subsequent shaping operation, prior to impregnation with the thermosetting resin.

The preform 11 of the future rudder is then shaped by inserting a block 20 of low density material into the pouch 18, which block has substantially the shape and the dimensions of the desired cavity. A consequence of this operation is to give the preform a shape that is closer to the shape desired for the rudder. This is the situation shown in FIG. 3.

The step shown in FIG. 4, optionally preceded by hot compacting, is a conventional step of impregnating the preform with the thermosetting resin. The preform shaped by inserting the block 20 of low density material is put into a stove-forming mold 22 so that the thermosetting resin can be injected therein. At the end of the impregnation operation, the rudder is finished off by being machined and by adding a tiller bar to one of its ends. It should be observed that the tiller may also be obtained essentially by weaving at one end of the preform. Provision may also be made to fit such an element at another end of the preform, before or after impregnation.

FIGS. 5 and 6 show a variant for fabricating a hollow part suitable for making an arbitrary structure. In this example, the purpose is to obtain a part of tubular shape including a utility passage 100. To do this, the preform 111 is woven to the required dimensions in a manner similar to that described above, i.e. taking care to form partial non-interlinking 119. While the preform is being shaped after weaving, it is possible to insert an inflatable member 120 into the slot that results from the non-interlinking and to fill it with a fluid (gas or liquid) so as to give it the shape and dimensions desired for the passage or cavity. This inflatable member 120 constitutes a kind of balloon and it is kept expanded throughout the impregnation step. Once the hollow part has been obtained, and its shape and dimensions have been finalized, the fluid is extracted, and the balloon may be removed or destroyed in place so as to release the utility passage 100.

1-7. (canceled)

8. A method of fabricating a hollow part, by making a preform by 3D weaving, comprising:
weaving weft yarns through a bundle of warp yarns arranged in a plurality of layers; and
impregnating the preform with a settable resin,
wherein during the weaving, the method comprising ensuring partial non-interlinking between two sheets of warp yarns and expanding the preform by creating a cavity of desired shape therein by the non-interlinking, and then impregnating the preform as shaped in this way with the resin.

9. A method according to claim 8, wherein the creating the cavity introduces into the preform, at a location of the non-interlinking, a block of low density material having a shape and dimensions of a desired cavity.

10. A method according to claim 8, wherein the creating the cavity inserts an inflatable member into the preform at a location of the non-interlinking, and fills the inflatable member with a fluid to give it a shape and dimensions of a desired cavity; and
after the impregnating, the method further comprising extracting the fluid and possibly the inflatable member from the cavity.

11. A hollow part obtained by 3D weaving of a preform and by impregnating the preform with a settable resin, the part including a cavity defined by expanding the preform, as made possible by non-interlinking during the 3D weaving.

12. A hollow part according to claim 11, wherein the cavity is filled with a low density material, so as to achieve an overall reduction in weight.

13. A hollow part according to claim 11, wherein the cavity forms a utility passage.

14. A hollow part according to claim 11, wherein the hollow part constitutes a rudder or a centerboard.

15. A hollow part according to claim 12, wherein the hollow part constitutes a rudder or a centerboard.
